(19) United States
(12) Patent Application Publication
(10) Pub. No.: US 2011/0205570 A1
(43) Pub. Date: Aug. 25, 2011

(54) PRINTER AND METHOD OF CONTROLLING THE SAME

(75) Inventor: Okiharu Matsuda, Shizuoka (JP)

(73) Assignee: TOSHIBA TEC KABUSHIKI KAISHA, Tokyo (JP)

(21) Appl. No.: 12/869,004

(22) Filed: Aug. 26, 2010

(30) Foreign Application Priority Data
Feb. 23, 2010 (JP) 2010-37884

(51) Int. Cl. G06K 15/00; G06F 7/04

(52) U.S. Cl. 358/1.14; 340/5.82

(57) ABSTRACT

According to one embodiment, a printer includes a sensing unit configured to detect biometric information of a user, and an authentication unit configured to authenticate the user identified by the detected biometric information. The printer further includes a determination unit configured to determine product-related processes which the authenticated user is authorized to execute, and an execution unit configured to execute the determined product-related processes.

### CROSS-REFERENCE TO RELATED APPLICATIONS

This application is based upon and claims the benefit of priority from Japanese Patent Application No. 2010-37884, filed on Feb. 23, 2010, the entire contents of which is incorporated herein by reference.

### FIELD

Embodiments described herein relate generally to a printer with a scanner and a method thereof controlling the same.

### BACKGROUND

A printer with a scanner reads product information from a bar code, which is printed on a tag attached to a product, and executes processes related to the product identified by the product information. In general, when powered on, a printer with a scanner executes an authentication process with a user code and a password, to prevent an unauthorized user from using the printer.

Also, a printer with a scanner has been developed to restrict users (depending on user classification) from executing particular processes including manually inputting a discount amount, printing a price tag, printing a discount label, etc. For example, a user classified as a manager may be authorized to execute all processes that the printer can perform, while a simple user may be allowed only to print discount labels.

### BRIEF DESCRIPTION OF THE DRAWINGS

FIG. 1 is a diagram showing the external appearance of a handy scanner according to one embodiment.

FIG. 2 is a diagram showing the internal structure of a handy scanner according to one embodiment.

FIG. 3 is a block diagram showing the configuration of a handy scanner according to one embodiment.

FIG. 4 is a functional block diagram of a handy scanner according to one embodiment.

FIG. 5 is a flowchart for executing related processes.

### DETAILED DESCRIPTION

According to one embodiment, a printer includes a sensing unit configured to detect biometric information of a user, and an authentication unit configured to authenticate the user identified by the detected biometric information. The printer further includes a determination unit configured to determine product-related processes which the authenticated user is authorized to execute and an execution unit configured to execute the determined product-related processes.

Embodiments will now be described in detail with reference to the accompanying drawings.

Embodiments will be described with respect to an exemplary handy scanner, which emits light on a bar code printed on a product tag and reads an image of the reflected light thereof.

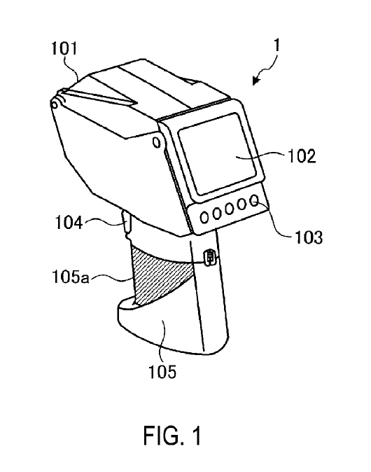

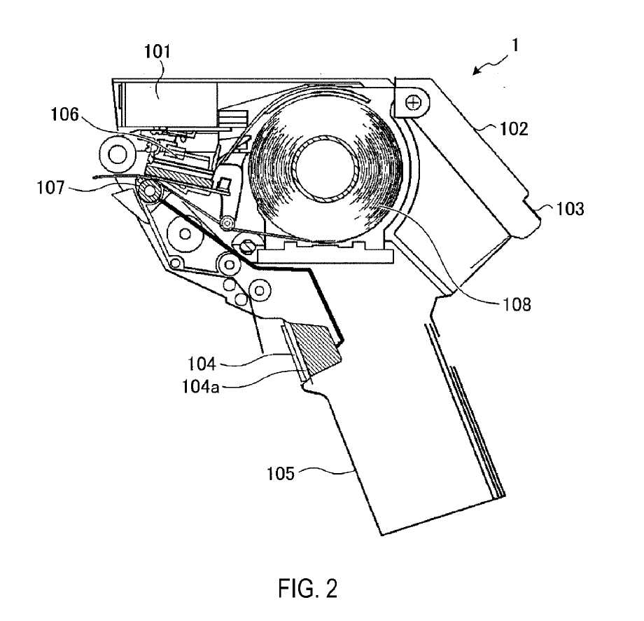

FIG. 1 is a diagram showing the external appearance of a handy scanner according to one embodiment. FIG. 2 is a diagram showing the internal structure of a handy scanner according to one embodiment. According to one embodiment, a handy scanner 1 includes a scanner 101, a display 102, a key input unit 103, a trigger switch 104, a grip 105, a thermal head 106, a platen roller 107, and a roll sheet 108.

The scanner 101 is a reading unit which emits light against a bar code or a two-dimensional code printed on a product tag, and reads product information identifying the product based on the reflected light thereof. However, it is appreciated that embodiments described herein are not limited to the above type of a reading unit. For example, the scanner 101 may include a reading unit which emits infrared light on a bar code or a two-dimensional code, and reads product information identifying the product from the reflected light wave thereof. Alternatively, the scanner 101 may include a reading unit which reads product information by reading and analyzing image data using a CCD (Charge Coupled Device) scanner, or a wireless communication unit which reads product information stored in a wireless tag, such as an RFID (Radio Frequency Identification) tag.

The display 102 is a liquid crystal display which displays product information or operation information (for example, a manually input discount amount). The key input unit 103 allows a user to input the operation information.

The grip 105 is a portion where a user grips the handy scanner 1. A portion indicated by reference numeral 105a is formed of conductive polymer material. The conductivity of the portion 105a, which is one of the physical properties of conductive polymer material, allows static electricity induced on the handy scanner 1 to be discharged through a human body part in contact with the portion 105a.

The trigger switch 104 is mounted on the grip 105 for requesting the handy scanner 1 to read product information.

The trigger switch 104 further includes a sensing unit 104a which detects fingerprint information of an operator of the trigger switch 104. It is appreciated that although in this embodiment the sensing unit 104a detects fingerprint information, the sensing unit 104a is not limited thereto. For example, the sensing unit 104a may senses biometric information of a user, such as vein information. In this embodiment, the sensing unit 104a is attached to the grip 105. Alternatively, the sensing unit 104a may be attached to any portion of the handy scanner 1 where biometric information of a user may be sensed. For example, if the handy scanner 1 is used while being wrapped around a user's arm, the sensing unit 104a is attached to a portion in contact with the user's arm. If the sensing unit 104a is provided on the trigger switch 104 as described in this embodiment, the sensing unit 104a is attached to an appropriate portion of the handy scanner 1, considering factors such as whether a contact finger is on the left or right hand, what size a contact finger has.

The platen roller 107 is arranged opposed to the thermal head 106, which will be described later. The platen roller 107 is a conveying roller which draws out a label with backing sheet from the roll sheet 108 and conveys the label with backing sheet to reach a printing position of the thermal head 106. The platen roller 107 is formed of conductive polymer material, thereby maintaining the conductivity.

The thermal head 106 prints a discount amount or price tag by heating a label with backing sheet when the platen roller 107 conveys the label with backing sheet to the printing position.

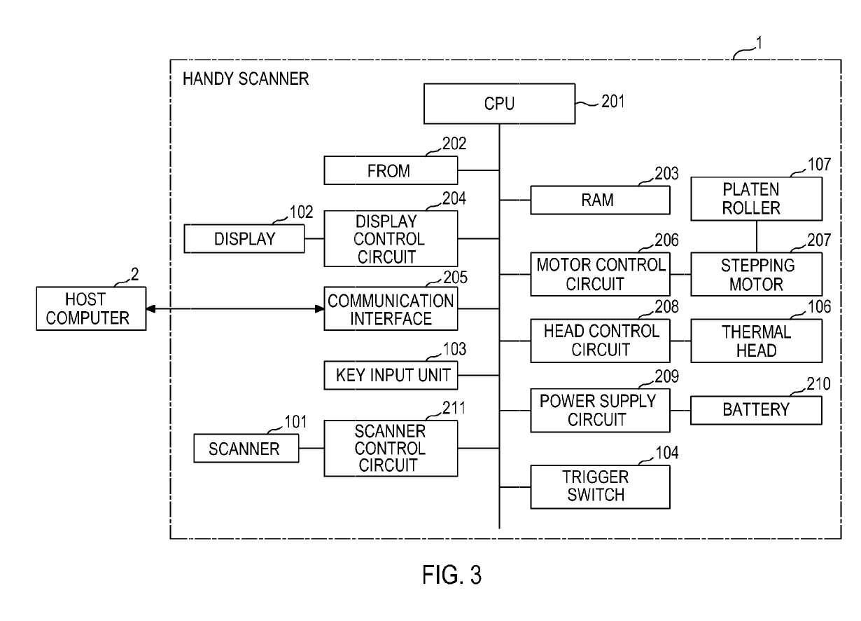

FIG. 3 is a block diagram showing the configuration of a handy scanner 1 according to one embodiment. According to this embodiment, the handy scanner 1 includes a CPU (Central Processing Unit) 201 which executes various arithmetic processes to centrally control respective parts. The CPU 201 is connected to a RAM (Random Access Memory) 203 and an FROM (Flash Read Only Memory) 202 via a system bus. The FROM 202 is a nonvolatile storage unit, which may retain information even when power is off.

The FROM 202 stores an operation program or various setting information of the handy scanner 1. The CPU 201 controls respective parts by copying an operation program from the FROM 202 to the RAM 203 and executing the operation program. The operation program may include a program which executes a product-related process such as printing a discount amount or price tag, and manually inputting a discount amount. Additionally, the FROM 202 stores a fingerprint information table where a user is associated with the user's fingerprint information. The FROM 202 further stores a manager class table where a user in a manager class is associated with processes which the user in that class is authorized to execute, and a user class table where a user in a user class is associated with processes which the user that class is authorized to execute.

The RAM 203 temporarily stores various types of variable information. The RAM 203 stores a print information table where a user operating the handy scanner 1 to print is associated with print information indicating the number or content of print sheets actually printed by the user. The RAM 203 further stores a time information table where a user operating the handy scanner 1 to print is associated with time information indicating time when the user operates the handy scanner 1 to print. Additionally, if the handy scanner 1 is equipped with a clock function, the RAM 203 temporarily stores date/time information indicating when a user actually operates the handy scanner 1 to print, and information regarding the user.

The RAM 203 is used as a print buffer where print data (image data) of a discount amount or price tag is deployed to be printed on a label with backing sheet. The print data may be received from a host computer 2 as information to be printed, may be stored in the FROM 202, and may be a discount amount input from the key input unit 103.

The CPU 201 is connected to a display control circuit 204, a communication interface 205, a motor control circuit 206, a head control circuit 208, a power supply circuit 209, a scanner control circuit 211, and the key input unit 103, and the trigger switch 104 via a system bus.

Under the control of the CPU 201, the display control circuit 204 controls displays in the display 102 (a menu screen including a graphical interface for selecting related processes). The communication interface 205 is an interface for communicating with an external device such as the host computer 2. For example, the communication interface 205 may use infrared communication such as IrDA, a USB (Universal Serial Bus), a wireless LAN (Local Area Network), RS232C, Bluetooth® to communicate with a communication interface installed in the host computer 2.

Under the control of the CPU 201, the motor control circuit 206 controls a stepping motor 207 as a drive source of the platen roller 107. Under the control of the CPU 201, the head control circuit 208 outputs a print control signal to the thermal head 106. Under the control of the CPU 201, the scanner control circuit 211 controls the scanner 101 to read product information.

The power supply circuit 209 controls the power supply from a battery 210 to respective parts of the handy scanner 1 according to power ON/OFF instructions of the handy scanner 1 input from the key input unit 103.

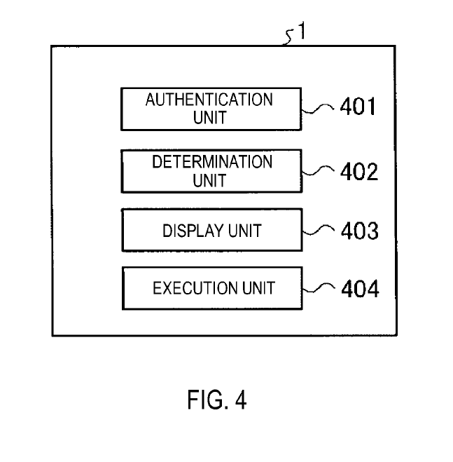

Next, functions of the CPU 201 will be described with reference to a functional block diagram shown in FIG. 4. The CPU 201 implements the functions by executing the operation programs stored in the FROM 202. FIG. 4 is a functional block diagram of a handy scanner according to one embodiment.

According to one embodiment, a program to be executed by the handy scanner 1 includes a module configuration including an authentication unit 401, a determination unit 402, a display unit 403, and an execution unit 404, as shown in FIG. 4. In the actual hardware configuration, the CPU 201 reads programs from the FROM 202 and executes them so that the units (the authentication unit 401, the determination unit 402, the display unit 403 and the execution unit 404) are loaded to be generated on the RAM 203.

When the sensing unit 104a provided in the trigger switch 104 detects fingerprint information, the authentication unit 401 authenticates a user identified by the fingerprint information. According to one embodiment, the authentication unit 401 authenticates the user identified by biometric information when the fingerprint information detected by the sensing unit 104a matches corresponding fingerprint information in the fingerprint information table stored in the FROM 202.

Subsequently, if the authentication unit 401 authenticates the user, the determination unit 402 determines a process(es) which the user is authorized to execute. For example, if the authenticated user is a manager, the determination unit 402 determines processes associated with the authenticated user in the manager class table stored in the FROM 202 (i.e., printing a discount amount or price tag, and manually inputting a discount amount) as processes which the user is authorized to execute. On the other hand, if the authenticated user is a simple user, the determination unit 402 determines processes associated with the authenticated user in the user class table stored in the FROM 202 (i.e., printing a discount amount or price tag) as processes which the user is authorized to execute.

The display unit 403 displays a menu on the display 102. The menu includes a graphical interface (e.g., a button) for selecting a desired process among the processes determined by the determination unit 402.

The execution unit 404 executes the processes determined by the determination unit 402, and executes the process selected through the graphical interface in the menu displayed on the display 102 (for example, printing a discount amount or price tag or manually inputting a discount amount).

When the execution unit 404 executes a process to print a discount amount or price tag, the execution unit 404 stores a print information table, a time information table, and a print date/time in the RAM 203. While processes of printing a discount amount or price tag are not executed (for example, during a period of recharging power, during a predetermined period after an idle time), the execution unit 404 updates the print information table, the time information table, or the print date/time stored in the RAM 203 to be uploaded to the host computer 2.

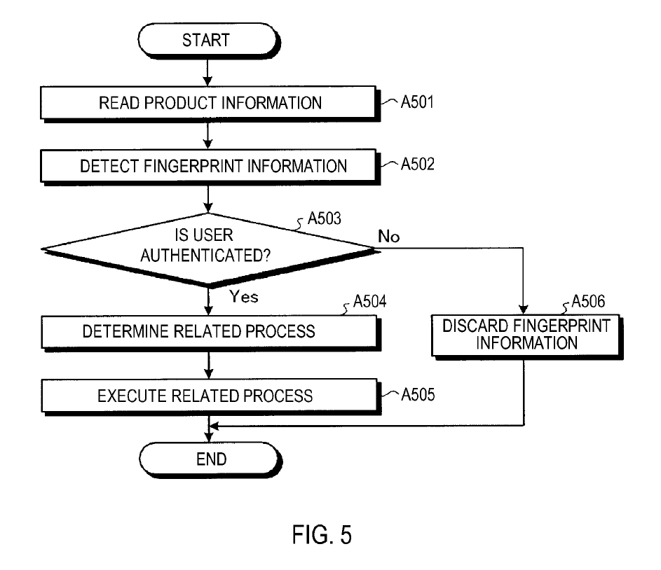

FIG. 5 is a flowchart for executing related processes. First, the scanner control circuit 211 controls the scanner 101 to read product information identifying a product from a bar code printed on a tag attached to the product (act A501). Further, the sensing unit 104a senses fingerprint information of a user's finger in contact with the trigger switch 104 (act A502).

A conventional printer with a scanner includes a sensor for detects fingerprint information mounted in a position constantly in contact with a user's finger, so that the sensor constantly detects fingerprint information. Since the conventional printer with the scanner is powered from a battery charger, the conventional printer with the scanner has a problem in reducing power consumption for detecting fingerprint information. However, according to this embodiment, the handy scanner 1 may detects fingerprint information only when the scanner 101 reads product information (i.e., when the trigger switch 104 is operated), thereby reducing power consumption further compared to the conventional printer with the scanner in which fingerprint information is constantly sensed.

Additionally, in a conventional printer with a scanner, once a manager inputs a user code or password to make a printer with a scanner in a executable state, a user (i.e., simple user) other than the manager may also operate the printer to execute processes which only the manager is authorized to execute (for example, manually inputting a discount amount). Thus, if a manager hands a printer with a scanner in operation over to a certain user, this causes a problem where the user may change a discount amount. However, according to this embodiment, the handy scanner 1 identifies fingerprint information whenever the scanner 101 reads product information. Therefore, even if a manager hands the handy scanner 1 in operation over to another user, the user may not perform processes such as changing a discount amount which only the manager is authorized to execute (for example, manually inputting a discount amount).

Further, in a conventional printer with a scanner, since a user has to input a user code or password each time he/she tries to use the printer, this may increase the work load of a user. Also, once a user code or password is disclosed, an unauthorized user may easily use the printer with the scanner for executing printing related processes. Thus, in the conventional printer with the scanner, it is necessary to periodically update user codes or passwords for respective users. However, according to this embodiment, the handy scanner 1 senses user's fingerprint information instead of inputting a user code or password. Thus, the operation of the printer may be easily performed without having to input a user code or password. Also, the leakage of a user code or password may be prevented without updating the user code or password.

When the scanner 101 reads the product information, the authentication unit 401 authenticates the user identified by the fingerprint information detected by the sensing unit 104a (act A503). If the user authentication fails (in case of “NO” in act A503), the authentication unit 401 discards the fingerprint information detected by the sensing unit 104a (act A506).

If the authentication unit 401 authenticates the user (in case of “YES” in act A503), the determination unit 402 determines which processes the authenticated user is authorized to execute among the processes related to the product identified by the product information read by the scanner 101 (act A504). The display unit 403 displays a menu on the display 102, which includes a graphical interface for selecting a desired process among the processes determined by the determination unit 401.

The execution unit 404 executes the process on which the graphical interface included in the menu displayed on the display 102 is manipulated (act A505).

According to the embodiments as described above, the handy scanner 1 includes the sensing unit 104a for detecting a user's fingerprint information, the authentication unit 401 for authenticating a user identified by the detected fingerprint information, the determination unit 402 for determining processes which the user is authorized to execute if the user is authenticated, and the execution unit 404 for executing the determined processes. Therefore, a user other than the authenticated user may be prevented from requesting to execute related processes, thereby improving the security level of the handy scanner 1.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a sensing unit configured to detect biometric information of a user;
an authentication unit configured to authenticate the user identified by the detected biometric information;
a determination unit configured to determine product-related processes which the authenticated user is authorized to execute; and
an execution unit configured to execute the determined product-related processes.

2. The printer of claim 1, further comprising:
a reading unit configured to read product information identifying a product; and
a switch configured to trigger the reading unit to read product information,
wherein the sensing unit is configured to detect biometric information of the user operating the switch.

3. The printer of claim 1, further comprising:
a display unit configured to display a graphical interface for selecting a desired process among the determined product-related processes,
wherein the execution unit is configured to execute the process selected through the displayed graphical interface.

4. The printer of claim 1, wherein if the determination unit determines that there are no product-related processes which the authenticated user is authorized to execute, the execution unit is configured to discard the detected biometric information.

5. The printer of claim 2, wherein the sensing unit is configured to detect fingerprint information as the biometric information of the user operating the switch.

6. The printer of claim 2, wherein the sensing unit is configured to detect vein information as the biometric information of the user operating the switch.

7. The printer of claim 2, wherein the sensing unit is mounted in the switch.

8. The printer of claim 7, wherein the sensing unit is configured to detect the biometric information of the user upon operating the switch to trigger the reading unit to read the product information.

9. A printer comprising:
a reading unit configured to read product information identifying a product;
a switch configured to trigger the reading unit to read product information;
a sensing unit mounted in the switch and configured to detect biometric information of a user;
an authentication unit configured to authenticate the user identified by the detected biometric information; and
a printing unit configured to allow the authenticated user to print product-related information.

10. The printer of claim 9, further comprising:
a determination unit configured to determine product-related processes which the authenticated user is authorized to execute;
a display unit configured to display a graphical interface for selecting a desired process among the determined product-related processes; and
an execution unit configured to execute the process selected through the displayed graphical interface.

11. The printer of claim 10, wherein if the determination unit determines that there are no product-related processes which the authenticated user is authorized to execute, the execution unit is configured to discard the detected biometric information.

12. The printer of claim 9 wherein the sensing unit detects biometric information of the user upon operating the switch to trigger the reading unit to read the product information.

13. A method of controlling a printer, comprising:
detecting biometric information of a user in a sensing unit;
authenticating the user identified by the detected biometric information in an authentication unit;
determining product-related processes which the authenticated user is authorized to execution in a determination unit; and
executing the determined product-related processes in an execution unit.

14. The method of claim 13, further comprising:
reading product information identifying a product in a reading unit; and
triggering the reading unit to read product information in a switch,
wherein the sensing unit detects biometric information of the user operating the switch.

15. The method of claim 13, further comprising:
displaying a graphical interface for selecting a desired process among the determined product-related processes in a display unit,
wherein the executing comprises executing the process selected through the displayed graphical interface in the execution unit.

16. The method of claim 13, further comprising discarding the detected biometric information in the execution unit upon determining there are no product-related processes which the authenticated user is authorized to execute in the determination unit.

17. The method of claim 14, wherein the detecting comprises detecting fingerprint information of the user operating the switch as the biometric information in the sensing unit.

18. The method of claim 14, wherein the detecting comprises detecting vein information of the user operating the switch as the biometric information in the sensing unit.

19. The method of claim 14, wherein the sensing unit is mounted in the switch.

20. The method of claim 17, wherein the detecting comprises detecting the biometric information of the user in the sensing unit upon operating the switch to trigger the reading unit to read the product information.
